(19) United States
(12) Patent Application Publication
(10) Pub. No.: US 2003/0067430 A1
(43) Pub. Date: Apr. 10, 2003

(54) Method for controlling timing of LCD driver

(75) Inventor: Hyung-suk Kim, Kyungki-do (KR)

Correspondence Address: Steven M. Mills, MILLS & ONELLO LLP, Suite 605, Eleven Beacon Street, Boston, MA, 02108, US

(73) Assignee: Samsung Electronics Co., Ltd.

(21) Appl. No.: 10/245,190

(22) Filed: Sep. 17, 2002

(30) Foreign Application Priority Data
Oct. 8, 2001 (KR) 01-61896

(51) Int. Cl. G09G 3/36

(52) U.S. Cl. 345/87

(57) ABSTRACT

Provided is a method for controlling the timing of a liquid crystal display (LCD) driver in which a write operation is first performed so that a scan operation and the write operation are not simultaneously performed, and controlling a circuit for driving the gate of a thin film transistor (TFT) and the gate of the TFT of a LCD panel that is turned off so that previous scan data are kept during the write operation, when the write operation and the scan operation of 6-TR SRAM having a single port structure are simultaneously performed so as to drive the LCD panel. The 6-TR SRAM comprised of 6 transistors can be used as a SRAM of the LCD driver, thereby reducing the size of the chip of the LCD driver and reducing power consumption.

### BACKGROUND OF THE INVENTION

1. Field of the Invention

The present invention relates to a liquid crystal display (LCD), and more particularly, to a method for controlling the timing of an LCD driver.

2. Description of the Related Art

In general, the operation of a thin-film transistor liquid crystal display (TFT-LCD) includes a write operation (or random access memory (RAM) write) for storing display data in a display RAM and a scan operation (or scan latch) for periodically outputting data stored in the display RAM to an output driver.

In the prior art, an 8-TR static random access memory (SRAM) comprised of 8 transistors is mainly used for a display RAM. Since a scan operation and a write operation of the 8-TR SRAM are performed respectively in separate areas, this structure is referred to as a dual port structure. As a result, a scan operation and a write operation do not coincide with each other.

FIG. 1 is a circuit diagram of an 8-TR SRAM comprised of 8 MOS transistors. Referring to FIG. 1, the 8-TR SRAM includes a RAM write block 101 and a scan latch block 103. Two transistors MN11 and MN12 for switching display data loaded into data lines BL and BLB and stored in a RAM, in response to a write command signal WL; four transistors MP11, MP12, MN13, and MN14 for forming a latch circuit for writing display data loaded into the data lines BL and BLB; and two transistors MN15 and MN16 for scanning display data, which are stored in the latch circuit, according to a scan command signal SA, are also illustrated in FIG. 1.

When the write command signal WL is enabled, the display data loaded into the data lines BL and BLB are transferred to or stored in the latch circuit through the two turned-on transistors MN11 and MN12. The latch circuit includes a first inverter 105 comprised of MP11 and MN13 and a second inverter 107 comprised of MP12 and MN14. The input of the first inverter 105 is connected to the output of the second inverter 107, and the input of the second inverter 107 is connected to the output of the first inverter 105. The latch circuit receives and stores the display data. loaded into the data lines BL and BLB when the two transistors MN11 and MN12 are turned on. The stored display data is not lost even when the two transistors MN11 and MN12 are turned off.

As mentioned above, the conventional 8-TR SRAM has the dual port structure in which a scan operation and a write operation are separately performed, and thus, no problems exist in using the 8-TR SRAM in an LCD driver in which a write operation and a scan operation are simultaneously performed. The size of the LCD display, more specifically, the number of pixels, increases, and thus, the number of RAMs increases. On the other hand, the size of chips for an integrated circuit (IC) should be reduced. Thus, the area of a RAM chip becomes a critical point when implementing an LCD driver with an IC.

In order to solve the problem, a 6-TR SRAM comprised of 6 transistors can be used in an LCD driver. However, the 6-TR SRAM has a single port structure in which a scan operation and a write operation are simultaneously performed. In the prior art, scanned data cannot be transferred to a TFT-LCD during a write operation, and this affects picture quality.

### SUMMARY OF THE INVENTION

To solve the above problems, it is an object of the present invention to provide a method for controlling the timing of a liquid crystal display (LCD) driver in which a write operation of a 6-TR SRAM having a single port structure is first performed so that a scan operation and the write operation are not simultaneously performed.

In accordance with the invention, there is provided a method for controlling the timing of a liquid crystal display (LCD) driver, wherein the method includes the steps of first performing a write operation, stopping a scan operation during the write operation and simultaneously keeping previously transferred scan data while alternately performing the write operation and the scan operation for a predetermined amount of time when the scan operation for scanning display data from display RAMs and transferring the scanned data to a LCD panel and the write operation for writing predetermined display data in the display RAMs are simultaneously performed.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a circuit diagram of an 8-TR SRAM comprised of 8 MOS transistors;

FIG. 2 is a circuit diagram of a 6-TR SRAM comprised of 6 MOS transistors;

FIG. 3 is a diagram of part of an LCD panel;

FIG. 4 is a circuit diagram illustrating a circuit equivalent to one cell of the LCD panel shown in FIG. 3; and

FIG. 5 is a flow chart illustrating a method for controlling the timing of an LCD driver according to the present invention.

### DETAILED DESCRIPTION OF THE INVENTION

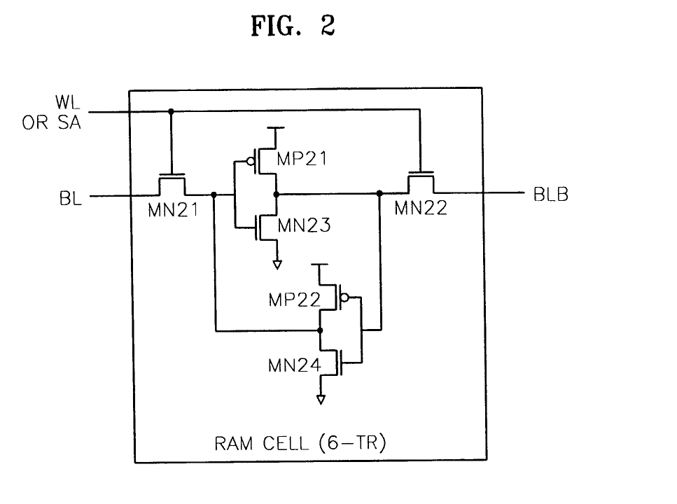

FIG. 2 is a circuit diagram of a 6-TR SRAM comprised of 6 MOS transistors. Referring to FIG. 2, the 6-TR SRAM includes four transistors MP21, MP22, MN23, and MN24 for forming a latch circuit for writing display data loaded into data lines BL and BLB, and two transistors MN21 and MN22 for transferring the display data loaded into the data lines BL and BLB and stored in the latch circuit to the latch circuit, in response to a write command signal WL or a scan command signal SA, or for switching the display data of the latch circuit so as to be transferred to the outside.

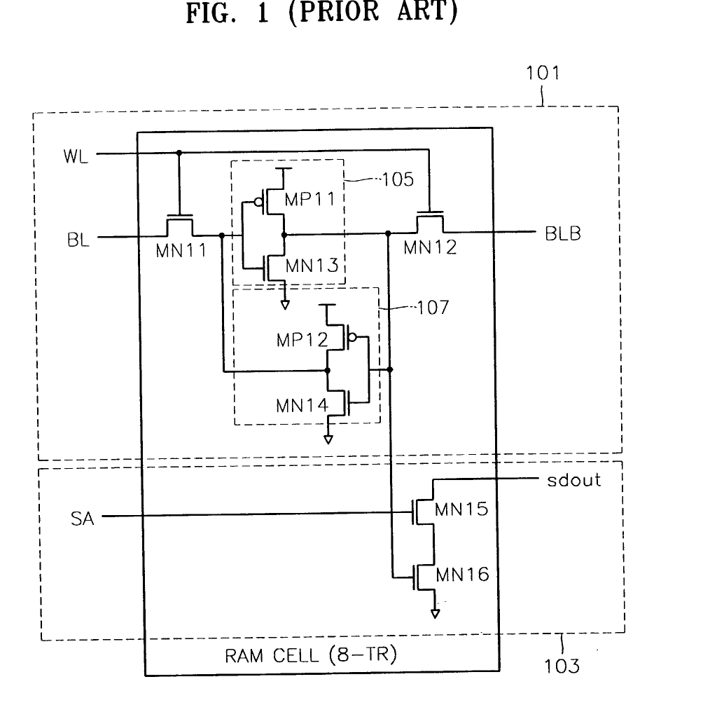

The structure of the four transistors MP21, MP22, MN23, and MN24 is the same as that of an 8-TR SRAM shown in FIG. 1, and thus, the descriptions thereof will be omitted.

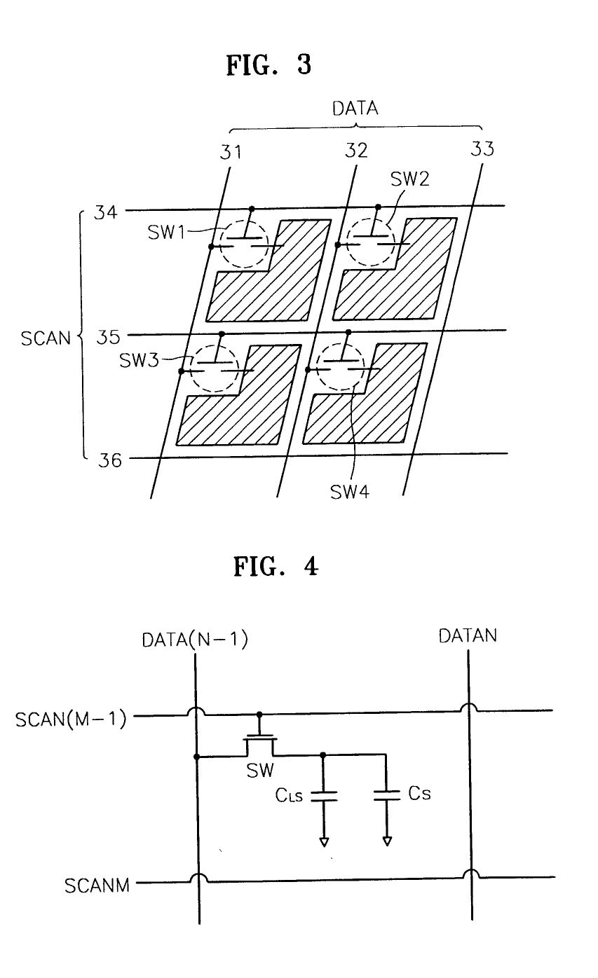

FIG. 3 is a diagram of part of an LCD panel. Referring to FIG. 3, the LCD panel includes pixels (regions indicated by diagonal lines), a plurality of data lines DATA 31, 32, and 33 having data to be stored in the pixels, a plurality of switches SW1, SW2, SW3, and SW4 for connecting the pixels to the plurality of data lines DATA 31, 32, and 33, and a plurality of scan lines SCAN 34, 35, and 36 for controlling the plurality of switches SW1, SW2, SW3, and SW4.

FIG. 4 illustrates a circuit equivalent to one cell of the LCD panel shown in FIG. 3. Referring to FIG. 4, the equivalent circuit includes an equivalent capacitor C_{Ls}, a storage capacitor Cₛ, and a thin film transistor (TFT)-switch SW.

The capacitance of the equivalent capacitor C_{Ls}, is determined by equivalent modeling using a liquid crystal. The storage capacitor Cₛ is included so as to store predetermined amount of time data and can be adjusted according to a desired design specification. The TFT-switch SW switches a data line DATA(N-1) for storing display data, switches the equivalent capacitor C_{Ls}, and switches the storage capacitor Cₛ according to the voltage level of a scan line SCAN(M-1).

Data, which is stored in the equivalent capacitor C_{Ls} and the storage capacitor Cₛ, can be kept for a predetermined amount of time in one cell of the LCD panel when the TFT-switch SW is turned off. The predetermined amount of time depends on the material, leakage path, and capacitance of the storage capacitor Cₛ rather than the equivalent capacitor C_{Ls}.

In consideration of the cell of the LCD panel having the above-mentioned latch structure, another operation can be performed for the predetermined amount of time without a scan operation. The essence of the present invention is to perform a write operation for the predetermined amount of time. In order to effectively use the predetermined amount of time, when the write operation and the scan operation should be simultaneously performed, the write operation is first performed. No effects are caused by the discontinuance of the scan operation on the screen of the LCD panel even if the scan operation stops during the write operation, and thus a user cannot recognize this.

In conclusion, the 6-TR SRAM having the single port structure can be used as a RAM of an LCD driver so as to drive the LCD panel.

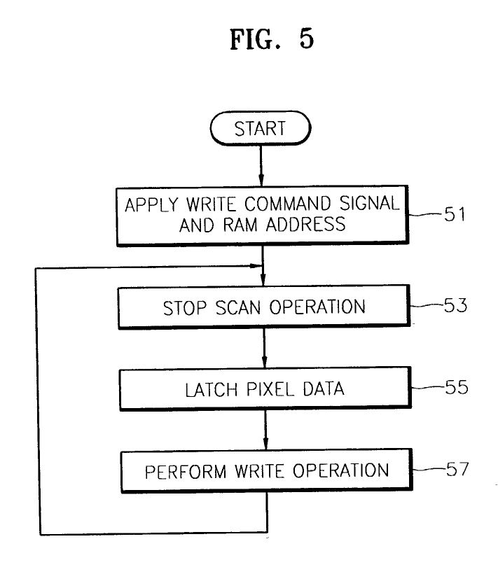

FIG. 5 is a flow chart illustrating a method for controlling the timing of an LCD driver according to the present invention. Referring to FIG. 5, the method includes the steps of applying a write command signal for initiating a write operation and applying a RAM address during a scan operation (step 51), stopping a scan operation in response to the write command signal (step 53), latching data stored in the pixels of the LCD panel, according to the write command signal (step 55), and performing a write operation for writing display data in the display RAMs, which are designated by the RAM address, according to the write command signal (step 57).

Steps 51 through 57 are repeated when the write command signal and the RAM address are applied repeatedly during the scan operation.

In step 55, it is preferable that a signal applied to the gate of the TFT of a LCD panel is controlled according to the write command signal and that all TFTs of the LCD panel are turned off.

The steps shown in FIG. 5 illustrate only one embodiment and the order of the steps may be varied.

As described above, in the method for controlling the timing of the LCD driver, the 6-TR SRAM comprised of 6 transistors can be used as a SRAM of the LCD driver, thereby reducing the size of the chip of the LCD driver and reducing power consumption.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for controlling the timing of a liquid crystal display (LCD) driver, wherein the method includes the steps of first performing a write operation, stopping a scan operation during the write operation and simultaneously keeping previously transferred scan data while alternately performing the write operation and the scan operation for a predetermined amount of time when the scan operation for scanning display data from display RAMs and transferring the scanned data to a LCD panel and the write operation for writing predetermined display data in the display RAMs are simultaneously performed.

2. The method of claim 1, wherein the method comprises:
applying a write command signal for initiating the write operation and applying a RAM address during the scan operation;
stopping the scan operation in response to the write command signal;
latching data stored in the pixels of the LCD panel, according to the write command signal; and
performing the write operation for writing the display data in the display RAMs, which are designated by the RAM address, according to the write command signal;
wherein the steps are repeated when the write command signal and the RAM address are applied during the scan operation.

3. The method of claim 2, wherein a signal applied to the gate of the TFT of the LCD panel is controlled according to the write command signal, and all TFTs of the LCD panel are turned off in the step of latching the data.

4. A method for controlling the timing of a liquid crystal display (LCD) driver, the method comprising:
applying a write command signal to initiate a write operation for storing display data in display RAMs and a RAM address during a scan operation for scanning display data from the display RAMs and transferring the scanned data to a LCD panel;
stopping the scan operation in response to the write command signal;
latching data stored in pixels of the LCD panel, according to the write command signal; and
writing the display data in the display RAMs, which are designated by the RAM address, according to the write command signal.

5. The method of claim 4, wherein a signal applied to the gate of the TFT of the LCD panel is controlled according to the write command signal, and all TFTs of the LCD panel are turned off in the step of latching the data.
